(19) United States
(12) Patent Application Publication
(10) Pub. No.: US 2023/0129571 A1
(43) Pub. Date: Apr. 27, 2023

(54) METHOD FOR CHECKING A PRESENT FUNCTIONAL STATE OF A BRAKE OF AN ELEVATOR INSTALLATION AND CORRESPONDINGLY CONFIGURED ELEVATOR INSTALLATION

(71) Applicant: Inventio AG, Hergiswil (CH)

(72) Inventor: MAX BRÜLLHARDT, Dierikon (CH)

(21) Appl. No.: 17/907,682

(22) PCT Filed: Apr. 6, 2021
(86) PCT No.: PCT/EP2021/058944

§ 371 Date: Sep. 29, 2022

(30) Foreign Application Priority Data
Apr. 6, 2020 (EP) 20168221.8

(51) Int. Cl. B66B 5/00; B66B 1/36

(52) U.S. Cl. CPC B66B 5/0037; B66B 1/36

(57) ABSTRACT

A method and brake monitoring device check a current functional state of a brake for an elevator installation traction sheave. The brake has a stationary part and a rotatable part rotationally fixedly coupled to the sheave. A braking mechanism has a displaceable braking element, a biasing mechanism and a release mechanism arranged on the stationary part. The biasing mechanism mechanically biases the braking element with an elastic biasing force toward a braking configuration. The release mechanism has an electrical actuator producing a force acting on the braking element and counteracting the elastic biasing force. The method includes: varying electrical power to the actuator; measuring a release power value that, when exceeded, causes the braking element to switch between the braking configuration and a released configuration; comparing the release power value with a predetermined reference power value; and determining the current functional state of the brake based the comparison result.

### FIELD

The present invention relates to a method for checking a current functional state of a brake in an elevator installation. The invention also relates to an elevator installation that is suitably configured for carrying out such a method, to a brake monitoring device for such an elevator installation, to a computer program product for suitable programming of such a brake monitoring device, and to a computer-readable medium with such a computer program product stored thereon.

### BACKGROUND

In elevator installations, typically at least one elevator car can be moved in an elevator shaft between height levels of different floors. In a frequently used type of elevator, the elevator car is held by a cable-type suspension means. The elevator car can be moved within the elevator shaft by displacing the cable-type suspension means. For this purpose, the suspension means generally runs over a traction sheave, which can be driven in rotation by a driving machine.

During operation of the elevator installation, it may be necessary in various situations to be able to reliably prevent the elevator car from moving within the elevator shaft. For example, during a stop at a floor, when a car door is opened and passengers are able to enter or exit the elevator car, the elevator car must be prevented from moving away from the floor and thus endangering the passengers.

For this purpose, elevator installations conventionally have at least one brake, which can used to reliably prevent or brake the rotation of the traction sheave driven by the driving machine.

In order to be able to guarantee the safety of the elevator installation, it must always be ensured that the brake can reliably prevent an unintentional displacement of the elevator car or, if necessary, can brake such an unintentional displacement quickly and efficiently. For this purpose, it must be possible to check a functional state of the brake in a suitable manner.

Possibilities of monitoring the braking force of an elevator brake are described in EP 3 080 034 B1.

### SUMMARY

Among other things, there may be a need for an alternative method for checking a current functional state of a brake of an elevator installation. In particular, there may be a need for such a method in which the current functional state of the brake can be determined with few or no additional components, i.e., without additional hardware expenditure, and in which no, or at most little, financial and/or labor-related expenditure is necessary to implement such a procedure. There may also be a need for an elevator installation or a brake monitoring device for an elevator installation that is able to execute or control the described method. In addition, there may be a need for a computer program product for programming such a brake monitoring device and for a computer-readable medium on which such a computer program product is stored.

A need of this kind can be satisfied by the subject matter according to any of the advantageous embodiments defined in the following description.

According to a first aspect of the invention, a method for checking a current functional state of a brake in an elevator installation is described. The elevator installation in this case has a driving machine which drives a traction sheave in rotation, wherein the traction sheave displaces a cable-type suspension means holding an elevator car as it rotates. The brake has a stationary part and a rotatable part that is rotationally fixedly coupled to the traction sheave. A braking mechanism is arranged on the stationary part. The braking mechanism comprises a displaceable braking element, a biasing mechanism, and a release mechanism. The braking element is displaceable between a braking configuration, in which the braking element frictionally interacts with the rotatable part of the brake, and a released configuration, in which the braking element does not frictionally interact with the rotatable part of the brake. The biasing mechanism mechanically biases the braking element toward its braking configuration with an elastic biasing force (sometimes referred to hereinafter simply as biasing). The release mechanism has an electrical actuator which, depending on an electrical power supplied to the actuator, produces a force which acts on the braking element and counteracts the elastic biasing produced by the biasing mechanism. The method comprises at least the following method steps, preferably in the order given:
varying the electrical power supplied to the actuator of the release mechanism and measuring a release power value which, when exceeded, causes the braking element to switch between the braking configuration and the released configuration;
performing a comparison between the release power value and a predetermined reference power value; and
determining the current functional state of the brake based on a result of the comparison.

According to a second aspect of the invention, an elevator installation is described. The elevator installation has an elevator car, a driving machine and a brake, all of which can have the properties described for embodiments of the first aspect of the invention. Furthermore, the elevator installation has a brake monitoring device, which is configured to carry out or control a method according to an embodiment of the first aspect of the invention.

According to a third aspect of the invention, a brake monitoring device is described which is designed for an elevator installation according to an embodiment of the second aspect and which is configured to carry out or control a method according to an embodiment of the first aspect of the invention.

According to a fourth aspect of the invention, a computer program product is proposed which contains instructions which, when executed by a programmable brake monitoring device according to an embodiment of the third aspect of the invention, cause it to execute or control a method according to an embodiment of the first aspect of the invention.

According to a fifth aspect of the invention, a computer-readable medium is described, on which a computer program product according to an embodiment of the fourth aspect of the invention is stored.

Possible features and advantages of embodiments of the invention can be considered, inter alia and without limiting the invention, to be based upon the concepts and findings described below.

As already mentioned in the introduction, an elevator installation must generally have at least one brake in order to be able to lock its elevator car in a fixed position within the elevator shaft, i.e., to be able to prevent it from moving inside the elevator shaft unintentionally. It must always be ensured that the brake is functional, i.e., it should be possible to check the current functional state of the brake as needed. In principle, this applies to all types of elevator installations.

Embodiments of the invention described herein relate to checking a current functional state of a specially designed brake in a specifically designed type of elevator installation. In order to be able to describe details in relation to the invention presented here, some basic properties of the type of elevator installation concerned are first explained below, which properties are necessary or at least helpful for the feasibility of the test procedure described below. Details of the test procedure and advantageous embodiments thereof are then described.

The elevator types envisaged by the invention are elevator installations in which an elevator car is both held and moved within an elevator shaft with the aid of cable-type suspension means. The suspension means can, for example, comprise a plurality of ropes, straps or belts. For this purpose, the suspension means runs over a traction sheave. The suspension means lie on the outer circumference of the traction sheave and friction between the suspension means and the traction sheave results in traction between the two components. The traction sheave is driven in rotation by a driving machine, which is controlled by an elevator control. The rotating traction sheave displaces the suspension means and thus the elevator car held thereon. The described type of elevator installation is sometimes called a traction sheave elevator and is used in particular in tall buildings in which a large number of floors are to be approached.

A frequently implemented option for braking a movement of the elevator car or for keeping the elevator car stationary in the elevator shaft by activating brakes is to be able to brake the rotatable traction sheave or components rotationally fixedly connected thereto.

A brake that can be used for this purpose generally has at least one stationary part and one rotatable part that is rotationally fixedly coupled to the traction sheave.

In this context, the stationary part of the brake can be understood to mean that part of the brake which is mounted, for example, on a stationary component of the elevator installation or a building holding the elevator installation in such a way that it cannot be set in rotation and, in particular, cannot move together with the rotating traction sheave. The stationary part of the brake can be fixed, for example, to a housing of the driving machine or to a part of the building that holds the driving machine. The stationary part of the brake may in turn consist of only one or preferably a plurality of components. These components may be displaceable relative to one another, but none of the components should be able to rotate conjointly with the rotation of the traction sheave. However, at least some of the components can be moved, for example, along linear paths or alternatively also along curved paths, i.e., for example, following a connecting link.

The rotatable part of the brake can be understood to mean that part of the brake which is directly or indirectly rotationally fixedly coupled to the rotatable traction sheave and can therefore rotate together with the traction sheave. The rotatable part of the brake can be, for example, a shaft coupled to the traction sheave, via which the traction sheave is driven by the driving machine, or a drum concentrically coupled to this shaft. Alternatively or additionally, the rotatable part of the brake can also be, for example, one or more brake discs, which are rotationally fixedly coupled to the traction sheave or its shaft.

A braking mechanism is arranged on the stationary part of the brake. This braking mechanism consists of a plurality of components and has at least one displaceable braking element, a biasing mechanism and a release mechanism.

The displaceable braking element can be a type of brake pad or brake lining, for example. The braking element may be supported by a displacement mechanism, for example in the form of a pivoting brake lever or a brake caliper, and can thus be displaced back and forth between different positions. In particular, the displacement mechanism can have, for example, one or more lever arms which can be rotated or pivoted about one or more axes.

The braking element is displaceable back and forth between a braking configuration and a released configuration. In the braking configuration, the braking element is positioned to frictionally interact with the rotating part of the brake. For this purpose, for example, a surface of the braking element is in mechanical contact with a surface of the rotating part of the brake, so that friction occurs at an interface between the two components, and the braking element thus produces a braking effect on the rotating part of the brake. In the released configuration, the braking element is positioned so that it does not frictionally interact with the rotating part of the brake. For this purpose, the braking element is, for example, at a distance from the surface of the rotating part of the brake, so that there is no significant braking friction due to the lack of mechanical contact between the two components.

The biasing mechanism of the braking mechanism is configured to mechanically bias the displaceable braking element toward its braking configuration with an elastic bias. In other words, the biasing mechanism is intended to exert a force on the displaceable braking element which is directed and dimensioned such that, in the absence of counteracting forces, the braking element is brought into its braking configuration, i.e., pushed toward a position in which it is applied against the rotating part of the brake to create a braking effect.

The biasing mechanism can be designed in such a way that the biasing force is effected elastically, i.e., when a force counteracting the biasing is produced, the braking element can be moved away from its braking configuration and toward its released configuration. For this purpose, the biasing mechanism can apply a force directed toward the rotating part of the brake to the braking element assigned thereto or to a displacement mechanism holding this braking element. This force biases the braking element toward the rotating part, but can be overcompensated by a corresponding opposing force, allowing the braking element to be moved into its released configuration as needed. However, as long as no overcompensating force acts, the mechanical biasing or force produced by the biasing element causes the braking element of the braking mechanism to be pressed into its braking configuration and thus the brake brakes or stops a rotating movement of the rotatable part of the brake.

To produce such a force, the biasing mechanism can have, for example, one or more elastic elements such as tension springs, elastomeric elements or the like. An elastic element can in this case, for example, act on the displacement mechanism for displacing the braking element and apply force thereto.

The release mechanism of the braking mechanism is configured to, if necessary, generate in a controlled manner that force which can be used to overcompensate for the mechanical bias produced by the biasing mechanism and thus to displace the braking element from its braking configuration to its released configuration. The entire brake can thus be temporarily released with the aid of the release mechanism in order to allow rotation of the rotatable part of the brake and thus of the traction sheave coupled thereto.

For this purpose, the release mechanism has an actuator which is configured to generate the desired force when it is actuated. In this case, the actuator can be actuated by supplying electrical power. The electrical power can be provided by applying an electrical voltage to the actuator or by the actuator producing an electrical current. The force produced by the actuator varies depending on the strength of the supplied electrical power. The force produced by the actuator preferably scales proportionally or linearly with the supplied electrical power.

Depending on the electrical power supplied, a more or less strong force can thus be produced which counteracts the elastic bias produced by the biasing mechanism. When the force produced by the release mechanism by means of an actuator overcompensates the force produced by the biasing mechanism, the displaceable braking element transitions from its braking configuration to its released configuration and the brake is thus released, i.e., is free running. If the release mechanism is then deactivated again, i.e., the electrical power supplied to its actuator is reduced and the force it produces is reduced until it no longer overcompensates for the force produced by the biasing mechanism, the displaceable braking element returns to its braking configuration and the brake is closed.

The above-described configuration of the elevator installation, and in particular of its driving machine and its brake, can largely correspond to that which is implemented in many conventional elevator installations.

Various approaches have been proposed for checking a current functional state of a brake in such elevator installations. Some of these approaches are based, for example, on directly measuring a force acting on the braking element or a force produced by the biasing mechanism. A mechanical force-measuring device, for example in the form of a load cell, can be used for this purpose. The force measuring device can be arranged, for example, between the braking element and the biasing mechanism and can detect the forces acting between the two components. However, such a force measuring device must generally be provided as an additional component in the brake of the elevator installation and can thus increase its complexity and/or costs.

With the approach presented here for checking the current functional state of a brake, the need for additional components can preferably be dispensed with, and increased complexity and/or costs can thus be avoided. Instead, components that already exist in the brake can preferably be used in a suitable manner in order to obtain information about the current functional state of the brake. To this end, the method proposed here substantially comprises the steps described below.

First, the electrical power supplied to the actuator of the release mechanism is varied. For example, the supplied electrical power can be successively increased from a minimum initial value to a maximum final value or, conversely, reduced from a maximum initial value to a minimum final value.

During the variation of the supplied electrical power, the time at which the braking mechanism or its braking element switches between the braking configuration and the released configuration is observed. In other words, there is monitoring of when the configuration of the braking element changes based on the variation of the power supplied to the actuator of the release mechanism. For this purpose, a value of the supplied electrical power is measured continuously or at short time intervals during the variation of the electrical power. In the event that the supplied electrical power is successively increased, it is possible to observe when the braking element transitions from its braking configuration to its released configuration. For the opposite case, in which the supplied electrical power is successively reduced, it is possible to observe when the braking element transitions from its released configuration to the braking configuration. A value of the supplied power at which, when exceeded, the braking element switches from the braking configuration to the released configuration, or vice versa, is referred to herein as the release power value.

After the release power value has been measured, it is compared to a predetermined reference power value. As will be explained in more detail below, it is possible to have determined this reference power value in advance in various ways. The reference power value can, for example, implicitly contain information about the electrical power supplied to the actuator at which the release mechanism is supposed to release or close the braking mechanism according to setpoint specifications when the brake is in a desired functional state.

Accordingly, the current functional state of the brake can ultimately be determined based on the previously performed comparison between the release power value and the reference power value. Information about this current functional state of the brake can be relayed to the elevator control, for example, so that it can decide, for example by analyzing this information, whether the brake is sufficiently functional and whether safe operation of the elevator installation is thus ensured. Alternatively or additionally, such information can also be forwarded to an external monitoring device, for example to a control center operated by a maintenance service.

To put it succinctly and simply, the test procedure proposed here can be used in a targeted manner to obtain information about the current functional state of the brake. The actuator of the release mechanism is successively subjected to different electrical voltages, or electrical currents of different strengths are produced therein, and it is observed when the force generated is strong enough that the mechanical bias applied to the braking element by the biasing mechanism is overcompensated and the braking element is thus displaced into its released configuration and when the force generated is not strong enough to do this. At the transition between the two states, the supplied electrical power is measured as the release power value. This release power value implicitly contains information about the current functional state of the brake and can be analyzed by comparing it to the predetermined reference power value. The information about the functional state of the brake obtained through the comparison can then be used in the elevator installation to ensure its safe operation.

According to one embodiment, the reference power value can be, for example, a reference value which was determined before the elevator installation was constructed. In other words, the reference power value can already be predetermined before the elevator installation and, in particular, its brake have been installed.

For example, the reference power value can be determined on the basis of experiments and/or trials to be carried out in advance on an identical brake or a prototype of the brake. For example, the biasing mechanism in this case can be set such that, when the release mechanism is completely deactivated, a bias is exerted on the braking element, which bias is large enough to produce a desired braking effect via frictional interaction with the rotating part of the brake. The force to be produced by the biasing mechanism for this purpose can, for example, be specified as a target force, and the force actually produced by the biasing mechanism can be measured or controlled directly, for example, using a force measuring device. The reference power value can then be, for example, that power value at which the electrical power supplied to the actuator of the release mechanism is large enough to generate a force via the actuator that overcompensates for the force produced by the biasing mechanism. In other words, the reference power value can be determined as that power value at which the force produced by the release mechanism becomes greater than the target force set in the biasing mechanism.

Alternatively or additionally, the reference power value can also be calculated analytically or numerically or can be determined using computer simulations. Here, for example, physical properties of components of the brake can be taken into account. For example, a modulus of elasticity of an elastic component used in the biasing mechanism to generate the mechanical bias can be taken into account in order to calculate or determine the force generated by the biasing mechanism, and then, based on this, the electrical power to be supplied to the actuator of the release mechanism, which power is required to compensate for this force, can be calculated or determined.

According to an alternative embodiment, the reference power value can be a measured power value. The power value can be determined after construction of the elevator installation and in particular immediately before the elevator installation is put into service, in particular specifically for the present installation, in particular by a technician on site, in particular as part of a teach-in operation, by varying an electrical power supplied to the actuator of the release mechanism and determining the measured power value as that measured power value which, when exceeded, causes the braking element to switch between the braking configuration and the released configuration.

In other words, the reference power value can be determined after the elevator installation, including its brake, has been constructed. The reference power value can be a real measured value. This measured value may be determined in a manner similar to how the release power value is determined during the method described herein. However, it preferably possible for the reference power value to have been determined in a state of the constructed elevator installation in which it has been ensured, for example due to other measures and/or additional measurements, that the brake and in particular its biasing mechanism meet the desired target specifications. In particular, it is possible for the reference power value to have been determined in a state of the elevator installation in which the brake was checked in advance, for example, by a technician for the presence of a desired functional state and/or in which there is still no significant wear on the brake and/or other components of the elevator installation.

The reference power value can be measured, for example, as part of a teach-in operation. For example, the reference power value can be determined directly after construction of the elevator installation and, if possible, before the elevator installation is put into operation by measuring the release power value during the variation of the electrical power supplied to the actuator of the release mechanism and then storing the release power value as the reference power value. During the subsequent operation of the elevator installation, currently measured release power values can then be compared to this previously recorded reference power value. The comparison can be used, for example, to identify signs of wear on the brake, in particular those signs of wear which affect the elastic biasing to be produced by the biasing mechanism.

It has proven to be advantageous that the reference power value is determined under the conditions actually prevailing in the installation. Tolerances that are required by the construction and/or installation of the system are also taken into account when determining the reference power value. It can therefore happen that, because of tolerances, different reference power values are determined for two installations that are identical (same type) on paper. Determining the reference power value in this way increases the accuracy of the method and thus reduces the probability that the method will judge a brake to be faulty even though the brake is still working properly. In this way, costs that arise due to a stopped installation and/or the deployment of a technician can be reduced.

The elevator installation can be designed in such a way that it allows the variation which is required during operation to carry out the test in a modified way, even during installation and before the system is finally put into operation, in order to determine the reference power value in the simplest manner possible, for example in as automatic a manner as possible.

According to one embodiment, the comparison can be carried out as a comparison between the release power value and a minimum permissible reference power value. In a case where the release power value is less than the minimum permissible reference power value, it can be determined as the current functional state of the brake that the biasing generated by the biasing mechanism is less than a minimum permissible biasing.

In other words, the predetermined reference power value can represent a lower limit. Such a minimum permissible reference power value can, for example, correspond to that power value which, when exceeded, causes the actuator of the release mechanism to generate a relatively small force, and this small force is already sufficient to compensate for the force generated by the biasing mechanism. If such a small force from the actuator is already sufficient for the compensation, this indicates that the force generated by the biasing mechanism is also relatively small. In this case, the minimum permissible reference power value can correspond to a situation in which the force generated by the biasing mechanism is small, but is still just enough for the brake to function reliably. If the release power value actually measured during the test procedure is less than such a minimum permissible reference power value, this can be interpreted to mean that the biasing generated by the biasing mechanism is insufficient to ensure an adequate braking effect of the brake. In such a case, it can be determined that the current functional state of the brake is insufficient and, for example, maintenance or repair of the brake is required.

If necessary or as a precautionary measure, the actually predetermined reference power value can be selected such that when an actual release power value corresponding to the reference power value is detected, a critical functional state of the brake has not actually been reached, but rather a certain period of time remains until such a critical functional state occurs. Accordingly, the minimum permissible reference power value can include a power value tolerance that is to be defined in a manner appropriate to the application. It can thus be achieved that when a current, critical functional state of the brake is detected, there is still sufficient time before this critical functional state actually occurs in order to be able to undertake countermeasures.

Alternatively or additionally, according to one embodiment, the comparison can be carried out as a comparison between the release power value and a maximum permissible reference power value. In a case where the release power value is greater than the maximum permissible reference power value, it can be determined as the current functional state of the brake that the biasing generated by the biasing mechanism is greater than a maximum permissible biasing.

In other words, the predetermined reference power value can represent an upper limit. Such a maximum permissible reference power value can, for example, correspond to that power value which must be supplied to the actuator of the release mechanism in order to generate a relatively large force, which is necessary to compensate for the force generated by the biasing mechanism. If such a large force has to be generated by the release mechanism in order to open the biasing mechanism, this can indicate that the biasing mechanism is set with too high a mechanical bias. Such a high mechanical bias can lead to overloads in the biasing mechanism or other components of the brake. If necessary, a case can even occur in which the force produced by the release mechanism is no longer able to release the biasing mechanism at all. This can mean that the brake is never completely released, which can lead to heavy wear on the brake during operation of the elevator installation. This can be detected, for example, if it is determined during the test procedure that the electrical power supplied to the actuator of the release mechanism cannot be increased to values at which the braking mechanism switches into its released configuration.

During the comparison, the release power value can possibly be compared both to a minimum permissible reference power value and to a maximum permissible reference power value. This makes it possible to determine whether the release power value is within a permissible power value range in which correct functioning of the brake can be assumed, or whether this power value range has been left.

According to one embodiment, the method is initiated by an authorized technician during installation, commissioning and/or maintenance of the elevator installation.

In other words, both the method itself and the brake monitoring device executing this method can be designed in such a way that it can be initiated preferably or exclusively by an authorized technician. An authorized technician can be, for example, a person who, due to their specialist knowledge and/or their affiliation with a company, is authorized to carry out installations, commissioning and/or maintenance for elevator installations. The method can be initiated, for example, by the brake monitoring device being actuated or activated, or by starting a suitable program in the brake monitoring device, according to which program the method is then carried out. In this case, the brake monitoring device can require the technician to prove his authorization before the method is started.

Alternatively or additionally according to one embodiment, the method can be repeated automatically at time intervals.

In other words, the brake monitoring device can, for example, be configured to automatically and repeatedly initiate the method at certain time intervals. The time intervals can be chosen to be periodic, i.e., the method is carried out repeatedly at fixed time intervals. Alternatively, the time intervals between repeated executions of the method can result from an initiation of the method being linked to the occurrence of specific events, i.e., the method is always carried out automatically when a specific event is detected in the elevator installation. For example, the functional state of the brake can be checked using the method whenever it is detected that the elevator installation is not currently being used by passengers, so that a test process can then be carried out undisturbed, during which process the brake is released briefly and the elevator car is moved, for example, for a test run.

According to one embodiment of the elevator installation proposed here, its brake can have at least two braking mechanisms that can be activated separately from one another. In this way, for example, redundancy can be achieved, thereby increasing the reliability of the brake. The method for checking the current functional state of the brake can be carried out with respect to both braking mechanisms.

According to one embodiment of the method proposed here, the variation of the electrical power supplied to the actuator of the release mechanism of one of the braking mechanisms should preferably only be carried out on one of the two braking mechanisms at any given instant.

In other words, it may be preferred not to change the respective actuator of the release mechanism on both braking mechanisms at the same time with regard to the electrical power supplied thereto, thereby possibly causing the braking elements of both braking mechanisms to transition to their released configuration at the same time. Instead, the supply of electrical power to the actuators of the release mechanisms of the two braking mechanisms should be varied in chronological succession. This means that at no instant are the actuators on both release mechanisms actuated simultaneously in such a way that the associated braking mechanism is released. Accordingly, it can be achieved that, although each of the two braking mechanisms can be checked individually with regard to a current functional state, the entire brake with its two braking mechanisms does not have to be released, which would result in the risk that the elevator car, which is then unbraked, would move in an uncontrolled manner. Instead, one of the braking mechanisms always remains in the braking configuration with its braking element, so that the brake as a whole can still prevent the elevator car from uncontrolled movements, while the other braking mechanism is checked for its current functional state as part of the method proposed here, and its braking element may be briefly moved into its released configuration.

According to one embodiment, the brake can have a brake contact switch, which is configured to detect a switching of the braking element between the braking configuration and the released configuration.

The brake contact switch may be a switch that is actuated or unactuated depending on whether the braking element is in the braking configuration or the released configuration. A transition of the braking element from its braking configuration to its released configuration or vice versa is thus accompanied by a change in a switching state of the brake contact switch.

The change in the switching state of the brake contact switch can thus serve as an initiating or triggering feature for the release power value to be measured during the variation of the electrical power supplied to the actuator of the release mechanism.

The braking contact switch can be, for example, a mechanical switch that is activated or deactivated when the braking element or a component mechanically coupled thereto moves from the braking configuration to the released configuration. Alternatively, the braking contact switch can also be any other type of switch, for example an inductive switch, a capacitive switch, an optical switch, etc., which can be used to detect a switching of the braking element between the braking and the released configuration.

According to one embodiment, the actuator of the release mechanism comprises an electromagnet which, by supplying the electrical power, produces the force acting on the braking element and counteracting the elastic bias produced by the biasing mechanism.

In other words, an electromagnet can be used as an actuator of the release mechanism, in response to the electrical power to be supplied, to produce that force with which the biasing otherwise produced by the biasing mechanism can be overcompensated.

In this case, the electromagnet can have a coil which, by supplying the electrical power, generates a magnetic field which in turn pushes a displaceable actuator into a position to produce the force.

An actuator designed with an electromagnet has a simple structure and is easy to control. In addition, the electromagnet can be switched in such a way that it does not generate any force in the event of a power failure, so that the biasing mechanism presses the braking element into its braking configuration.

The brake monitoring device according to the third aspect of the invention, which device is designed to carry out or control the method proposed herein, can be an electrical or electronic device which is configured to measure the electrical power supplied to the actuator of the release mechanism and to detect when the braking element of the braking mechanism switches between the braking configuration and the released configuration, in order to then set the measured power as the released power value. In order to be able to measure the supplied electrical power, the brake monitoring device can, for example, measure the electrical voltage applied to the actuator from a power source or a current flowing in the actuator. The power source itself can vary the power supplied in the course of the procedure. Alternatively, the power source can also deliver a constant power and the power ultimately supplied to the actuator can be varied by another device, such as the brake monitoring device.

The brake monitoring device can also have a data processing unit, for example in the form of a processor, with which data reflecting the measured release power value can be processed and compared in particular to the predetermined reference power value. In addition, the brake monitoring device can have a data memory in which such data can be stored in a volatile or non-volatile manner. Furthermore, the brake monitoring device can have various data interfaces. One of these data interfaces can be configured to communicate with a brake contact switch and to read out its switching states. A data interface can also be provided, via which information relating to the determined current functional state of the brake can be output and forwarded, for example, to the elevator control.

The brake monitoring device can be a separate component within the elevator installation or can be integrated into another component, such as the elevator control.

The computer program product according to the fourth aspect of the invention contains computer-readable instructions that can be executed by a computer-like device such as the programmable brake monitoring device described above and instruct it to carry out or control the method according to an embodiment of the first aspect of the invention. The computer program product can be formulated in any computer language.

The computer-readable medium according to the fifth aspect of the invention has a computer program product stored thereon according to the fourth aspect of the invention. The computer-readable medium can be a data store of any configuration, such as a CD, a DVD, a flash memory, a ROM, a PROM, an EPROM or the like. Alternatively, the computer-readable medium can also be part of a separate computer, server or cloud from which the computer program product can be downloaded via a network such as the Internet.

It must be noted that some of the possible features and advantages of the invention are described herein with reference to different embodiments of the test procedure, on the one hand, and, on the other hand, an elevator installation or brake monitoring device designed to carry out method. A person skilled in the art will recognize that the features can be suitably combined, adapted, or replaced in order to arrive at further embodiments of the invention.

Embodiments of the invention will be described below with reference to the accompanying drawings; neither the drawings nor the description should be interpreted as limiting the invention.

### DESCRIPTION OF THE DRAWINGS

FIG. 1 is a sectional view through an elevator installation according to an embodiment of the present invention.

FIG. 2 is a front view of a brake of an elevator installation according to one embodiment of the present invention.

The drawings are merely schematic and not to scale. Like reference signs denote like or equivalent features in the various drawings.

### DETAILED DESCRIPTION

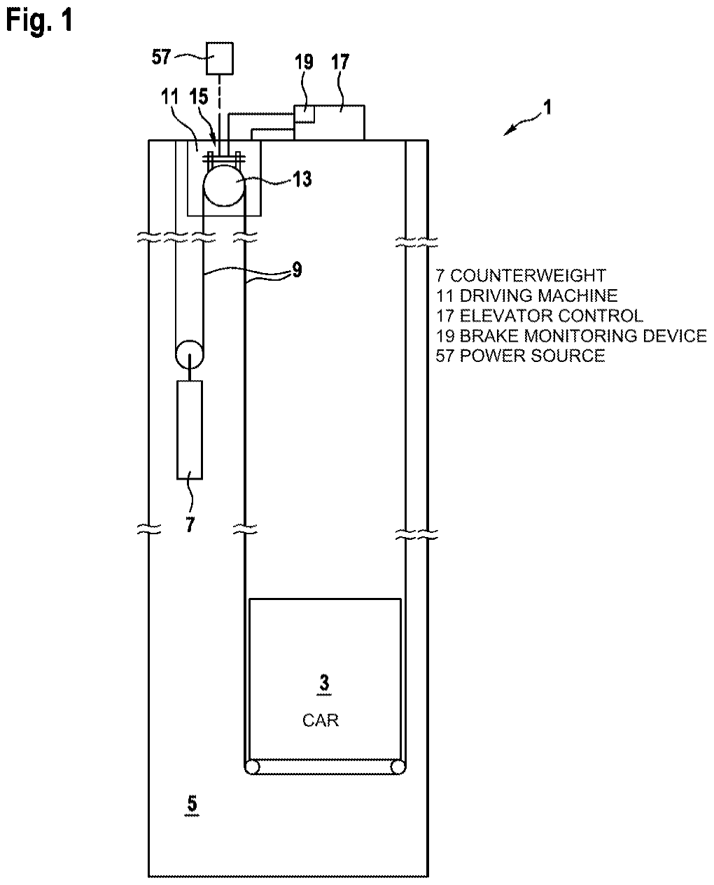

FIG. 1 shows an elevator installation 1 which is configured to carry out a method for checking a current functional state of a brake of the elevator installation 1 according to one embodiment of the present invention.

The elevator installation 1 comprises an elevator car 3, which can be displaced within an elevator shaft 5 using a driving machine 11. For this purpose, the elevator car 3 is held by cable-type suspension means 9 which run over a traction sheave 13 driven by the driving machine 11 and which also hold a counterweight 7.

A brake 15 is provided on the driving machine 11. The brake 15 is designed to brake a rotation of the traction sheave 13 of the driving machine 11 or to prevent the traction sheave 13 from such a rotation. For this purpose, the brake 15, like the driving machine 11, is controlled by an elevator control 17. In addition, a brake monitoring device 19 is integrated in the elevator control 17, with the aid of which device the current functional state of the brake 15 can be monitored.

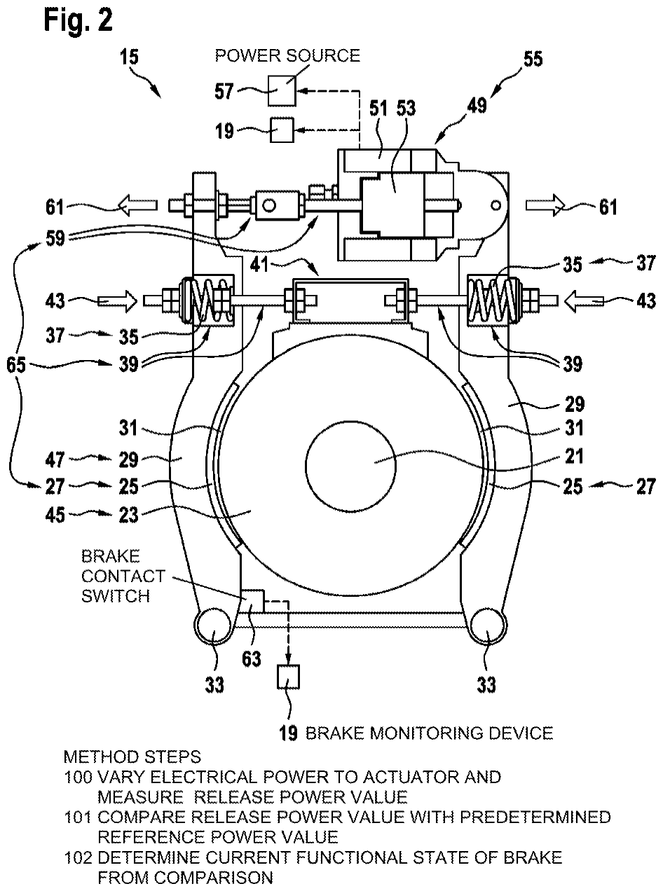

One possible embodiment of a brake 15 to be used in the elevator installation 1 is shown in FIG. 2.

The brake 15 has a rotatable part 45 and a stationary part 47.

The rotatable part 45 is rotationally fixedly coupled to the traction sheave 13 to be driven in rotation by the driving machine 11. For example, the rotatable part 45 can be designed as a brake drum 23 which is rotationally fixedly coupled to a drive shaft 21 via which the driving machine 11 drives the traction sheave 13.

In contrast to the rotatable part 45, the stationary part 47 of the brake 15 cannot rotate together with the traction sheave 13 or with components coupled thereto. Instead, the stationary part 47 is fixed in place, for example on the driving machine 11 or on a part of the elevator installation 1 or of the building that houses the elevator installation 1.

In the example shown, the stationary part 47 has a braking mechanism 65 which is composed of a displaceable braking element 27, a biasing mechanism 39 and a release mechanism 59.

In this case, the displaceable braking element 27 is designed as a brake lining 25 which is attached to a brake lever 29. The braking element 27 can be switched between a braking configuration, in which the braking element 27 bears with one surface against the rotatable part 45 of the brake 15 and thus interacts frictionally with it, and a released configuration shown in the drawing, in which configuration the braking element 27 does not interact with the rotating part 45 of the brake 15. For this purpose, the brake lever 29 can be pivoted about a pivot bearing 33 to which one end of this brake lever 29 is attached. In the released configuration, the braking element 27 is spaced apart by a gap 31 from a peripheral surface of the brake drum 23 that forms the rotatable part 45.

In fact, the brake 15 in the example shown has two displaceable braking elements 27 in the form of two brake linings 25 which are each arranged symmetrically to the drive shaft 21 on a respective brake lever 29. The brake levers 29 and their respective brake linings 25 partially surround the brake drum 23 from opposite sides.

The biasing mechanism 39 of the brake 15 or the braking mechanism 65 is designed to act on the brake levers 29 with a biasing force 43 directed toward the other brake lever 29. For this purpose, a stationary counter bearing 41 is connected via a rod to a spiral spring 35 acting as an elastic element 37. The spiral spring 35 is supported on an upper part of the associated brake lever 29 and is biased in such a way that the brake lever 29 together with the brake lining 25 provided thereon is acted upon by the biasing force 43 in a direction toward the outer surface of the brake drum 23. Thus, the braking element 27 is pressed with the biasing force 43 toward its braking configuration.

In order to be able to release the brake 15, i.e., to be able to displace the braking element 27 from its braking configuration to its released configuration, the braking mechanism 65 also has the release mechanism 59.

In the example shown, the release mechanism 59 has an actuator 55 in the form of an electromagnet 49. The electromagnet 49 comprises a coil 51 and a piston 53 that is displaceable relative to the coil 51. The coil 51 can be supplied with electrical power from a power source 57. Depending on the supplied electrical power, the coil 51 generates a magnetic field which seeks to displace the piston 53. Because on the one hand a housing of the electromagnet 49 holding the coil 51 and on the other hand a push rod connected to the piston 53 interact with respective ends of the two brake levers 29, a suitable power supply to the coil 51 can produce a force 61 which counteracts the biasing force 43.

Accordingly, the brake 15 can be released by suitably energizing the actuator 55 because its braking elements 27 are removed from the brake drum 23 by pressing the brake levers 29 apart. A brake contact switch 63 can in this case detect a switching of the braking mechanism 65 between the braking configuration and the released configuration.

On the one hand, the brake monitoring device 19 can determine how much power is currently being supplied by the power source 57 to the actuator 55. On the other hand, the brake monitoring device 19 can exchange signals with the brake contact switch 63 in order to detect the configuration in which the braking elements 27 are currently located.

In order to obtain information about the current functional state of the brake 15, the electrical power supplied to the actuator 55 of the release mechanism 59 can now be varied in a targeted manner. The electrical power currently supplied is measured, and that power which is measured when the braking elements 27 switch from their braking configuration to their released configuration, or vice versa, is defined as the release power value and stored. See step 100 in FIG. 2.

The release power value measured in this way is then compared to a predetermined reference power value. It is possible for the reference power value to have been determined beforehand, for example, by preliminary tests or as part of a teach-in operation. See step 101 in FIG. 2. The desired information about the current functional state of the brake 15 can then be derived based on the result of this comparison. See step 102 in FIG. 2.

In other words, one idea can be seen in measuring the mechanical braking force exerted by the coil springs 35 on the brake 15 by testing or measuring the electric current required either to open the brake or to keep the brake in the open state. In the event that the brake 15 has two braking mechanisms 65, this can be carried out individually for both braking mechanisms 65, because their two channels can be controlled independently of one another. If this is done individually, the test can be performed while one of the braking mechanisms 65 remains closed. Therefore, there is at most a very small risk that the elevator car 3 could move while the method is being carried out.

A specific design of the test procedure can be implemented as follows: as a precondition it is assumed that a safety circuit within the elevator installation is closed, i.e., all doors are closed. The elevator control then initiates what is known as a dummy trip and activates the inverter, which supplies the driving machine 11 with power. The inverter then starts and possibly biases an electric motor of the driving machine 11 with a torque (this is actually not absolutely necessary for the test, but may be necessary so that the brake can be opened). The electrical voltage applied to the brake 15, and thus also the electrical current, is then gradually increased. When the brake 15 opens, which is signaled in this case, for example, by the brake contact switch 63 changing state, an electrical current supplied to the brake is measured and stored or logged. The brake is then held open for a few seconds by applying the voltage for holding the brake. The voltage applied to the brake is then gradually reduced again. When the brake closes (again detectable based on a state change at the brake contact switch 63), the measured electrical current to the brake is again stored or logged. Finally, the brake is deactivated and the inverter switched off. The stored or logged electrical currents supplied to the brake can then be compared to reference values from which the current functional state of the brake can be derived, and finally the test process can be ended.

If the test is performed during a commissioning, the measured electrical current needed to open or hold open each brake can be stored as a reference. This reference value can then be used later, for example during maintenance of the elevator installation, as a reference power value for a comparison.

The test can be initiated manually, for example by man-machine interface activation by an authorized technician. Alternatively or additionally, the test can be carried out automatically, for example during maintenance, and/or repeated automatically at specific time intervals.

With the test procedure presented here, it can advantageously be found out, for example, whether the elastic element 37, i.e., the spiral spring 35, of the biasing mechanism 39 on the brake 15 is set too soft or too weak. Preferably, this can be detected before the brake fails completely. It can also be determined whether the elastic element 37 or the spiral spring 35 is too firm or strong, or whether the biasing force thereof degrades over time. Furthermore, with the aid of the test procedure proposed here, a commissioning of the elevator installation can be supported, for example in that mechanical adjustment or tightening of the spiral spring 35 is supported or is made verifiable. Overall, the safety of the elevator installation 1 can be improved as a result.

Finally, it should be noted that terms such as “comprising”, “having”, etc. do not exclude other elements or steps, and terms such as “a” or “an” do not exclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for checking a current functional state of a brake of an elevator installation, wherein the elevator installation includes a driving machine driving a traction sheave in rotation, wherein the traction sheave during rotation displaces a cable-type suspension means holding an elevator car, wherein the brake has a stationary part and a rotatable part that is rotationally fixedly coupled to the traction sheave, wherein a braking mechanism is arranged on the stationary part, wherein the braking mechanism has a displaceable braking element, a biasing mechanism and a release mechanism, wherein the braking element is displaceable between a braking configuration, in which the braking element frictionally interacts with the rotatable part of the brake, and a released configuration, in which the braking element does not frictionally interact with the rotatable part of the brake, wherein the biasing mechanism mechanically biases the braking element with an elastic biasing force toward the braking configuration, wherein the release mechanism has an electrical actuator that, depending on an electrical power supplied to the actuator, produces a force that acts on the braking element and counteracts the elastic biasing force produced by the biasing mechanism, the method comprising the steps of:
varying the electrical power supplied to the actuator of the release mechanism and measuring a release power value that, when exceeded, causes the braking element to switch between the braking configuration and the released configuration;
performing a comparison between the release power value and a predetermined reference power value; and
determining a current functional state of the brake based on a result of the performed comparison.

17. The method according to claim 16 including determining the reference power value by at least one of:
before the elevator installation is constructed;
immediately before the elevator installation is put into operation;
specifically for the elevator installation;
by a technician on a site where the elevator installation is installed; and
as part of a teach-in operation of the elevator installation.

18. The method according to claim 16 wherein the reference power value is a measured power value, the measured power value being determined after construction of the elevator installation by varying the electrical power supplied to the actuator of the release mechanism and determining the measured power value as a power value that, when exceeded, causes the braking element to switch between the braking configuration and the released configuration.

19. The method according to claim 16 including performing the comparison as a comparison between the release power value and a minimum permissible reference power value, and when the release power value is less than the minimum permissible reference power value, determining as the current functional state of the brake that the biasing force generated by the biasing mechanism is less than a minimum permissible biasing force.

20. The method according to claim 16 including performing the comparison as comparison between the release power value and a maximum permissible reference power value, and when the release power value is greater than the maximum permissible reference power value, determining as the current functional state of the brake that the biasing force generated by the biasing mechanism is greater than a maximum permissible biasing force.

21. The method according to claim 16 including initiating the method by an authorized technician during at least one of an installation, a commissioning and a maintenance of the elevator installation.

22. The method according to claim 16 including automatically repeating the method steps at predetermined time intervals.

23. The method according to claim 16 wherein the brake has two braking mechanisms that can be activated separately from one another, and wherein the varying the electrical power supplied to the actuator of the release mechanism is performed on each of the two braking mechanisms at different times.

24. An elevator installation comprising:
an elevator car;
a driving machine driving a traction sheave in rotation, wherein the traction sheave during the rotation displaces a cable-type suspension means holding the elevator car;
a brake having a stationary part and a rotatable part, the rotatable part being rotationally fixedly coupled to the traction sheave;
a brake monitoring device;
a braking mechanism arranged on the stationary part of the brake, the braking mechanism having a displaceable braking element, a biasing mechanism and a release mechanism;
wherein the braking element is displaceable between a braking configuration, in which the braking element frictionally interacts with the rotatable part of the brake, and a released configuration, in which the braking element does not frictionally interact with the rotatable part of the brake;
wherein the biasing mechanism mechanically biases the braking element with an elastic biasing force toward the braking configuration;
wherein the release mechanism has an electrical actuator that generates a force depending on an electrical power supplied to the actuator, the force acting on the braking element to counteract the elastic biasing force generated by the biasing mechanism; and
wherein the brake monitoring device is adapted to carry out or control the method according to claim 16.

25. The elevator installation according to claim 24 wherein the brake has two braking mechanisms that can be activated separately from one another.

26. The elevator installation according to claim 24 wherein the brake includes a brake contact switch that detects a switching of the braking element between the braking configuration and the released configuration.

27. The elevator installation according to claim 24 wherein the actuator of the release mechanism includes an electromagnet that responds to the supplied electrical power to generate the force that acts on the braking element and counteracts the elastic biasing force generated by the biasing mechanism.

28. A brake monitoring device for an elevator installation adapted to carry out or control the method according to claim 16.

29. A computer program product comprising a computer program means including computer readable instructions for performing the method according to claim 16 when the instructions are executed by a programmable brake monitoring device of an elevator installation.

30. A non-transitory computer-readable medium having the computer program product according to claim 29 stored thereon.
